(19) United States
(12) Patent Application Publication
(10) Pub. No.: US 2026/0292242 A1
(43) Pub. Date: Sep. 24, 2026

(54) EXTENSION OF EXTRAPOLATION INTRA PREDICTION CODING

(71) Applicant: MEDIATEK INC., Hsinchu City (TW)

(72) Inventors: Cheng-Yen CHUANG, Hsinchu City (TW); Yi-Wen CHEN, San Jose, CA (US); Tzu-Der CHUANG, Hsinchu City (TW); Ching-Yeh CHEN, Hsinchu City (TW); Chih-Wei HSU, Hsinchu City (TW); Yu-Wen HUANG, Hsinchu City (TW)

(21) Appl. No.: 19/472,059

(22) PCT Filed: Jul. 4, 2024
(86) PCT No.: PCT/CN2024/103471

§ 371 Date: Oct. 2, 2025

Related U.S. Application Data
(60) Provisional application No. 63/512,313, filed on Jul. 7, 2023.

(51) Int. Cl. H04N 19/593; H04N 19/172; H04N 19/176; H04N 19/436

(52) U.S. Cl. CPC H04N 19/593; H04N 19/172; H04N 19/176; H04N 19/436

(57) ABSTRACT

A method for coding a pixel block by using multiple source sample-based prediction is provided. A video coder receives data to be encoded or decoded as a current block of a current picture of a video. The video coder derives a linear model based on source and target samples collected from a template region neighboring the current block. The linear model generates a prediction for one target sample based on a set of neighboring source samples. The target sample is in a next row or next column to the set of source samples. The video coder applies the linear model to generate a predictor of the current block by traversing the linear model through each position of the current block. The video coder encodes or reconstructs the current block by using the generated predictor.

### CROSS REFERENCE TO RELATED PATENT APPLICATION(S)

The present disclosure is part of a non-provisional application that claims the priority benefit of U.S. Provisional Patent Application No. 63/512,313, filed on 7 Jul. 2023. Content of above-listed application is herein incorporated by reference.

### TECHNICAL FIELD

The present disclosure relates generally to video coding. In particular, the present disclosure relates to methods of coding pixel blocks by extrapolation intra prediction (EIP) mode.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for coding a pixel block by using multiple source sample-based prediction. A video coder receives data to be encoded or decoded as a current block of pixels of a current picture of a video. The video coder derives a linear model based on source and target samples collected from a template region neighboring the current block. The linear model generates a prediction for one target sample based on a set of neighboring source samples. The target sample may be in a next column or a next row to the set of source samples. The video coder applies the linear model to generate a predictor of the current block by traversing the linear model through each position of the current block. The video coder encodes or reconstructs the current block by using the generated predictor.

In some embodiments, the video coder may use reconstructed samples, predicted samples, or predefined values, as input to the linear model. The predicted samples as input may be predicted by an intra prediction mode (an angular directional mode, DC mode, planar mode, determined by TIMD or by DIMD, etc.), or predicted by the linear model for another pixel position.

In some embodiments, the linear model is applied to generate prediction for only a subset of the pixel positions of the current block. The subset of pixel positions may be in M rows closest to the top boundary of the current block and/or N columns closest to the left boundary of the current block, where M and N are positive integer values. In some embodiments, the video coder generates a first predictor by using the linear model and a second predictor by using an intra prediction mode, and the current block is encoded by combining the first and second predictors.

In some embodiments, for each sample position of the current block, one linear model is selected to be applied to generate a prediction for the sample position, where the linear model is selected from a plurality of linear models based on a comparison between an available sample for the sample position and a multi-model threshold. The multi-model threshold may be an average of reconstructed samples neighboring the current block. The available sample may be a prediction generated by an intra-prediction mode for the sample position. The available sample may also be a reconstructed sample or a predicted sample of a neighboring position.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIGS. 1A-C illustrate three types of filter kernels having fifteen inputs and generating one output that may be used by Extrapolation Intra Prediction (EIP).

FIGS. 2A-C illustrate three types of template regions in reconstructed areas neighboring a current block for providing samples to derive the EIP filter.

FIG. 3 conceptually illustrates a diagonal order according to which an EIP filter is applied to generate the predictions for the current block.

FIG. 4 conceptually illustrates the spatial components of a convolutional filter.

FIG. 5 shows a transform kernel selection process for planar horizontal and planar vertical mode.

FIG. 6 illustrates source and target samples in N×N square blocks of samples.

FIG. 7 illustrates source and target samples in MxN horizontal rectangular blocks of samples.

FIG. 8 illustrates source and target samples in MxN vertical rectangular blocks of samples.

FIG. 9 illustrates source and target samples in diamond shaped kernel blocks of samples.

FIG. 10 illustrates when the target sample is located in a row or column that is adjacent to the kernel block.

FIG. 11 illustrates boundary samples (top and/or left N lines of samples) to which Multiple source sample-based prediction (MSSBP) is applied.

FIG. 12 illustrates combining predictors of different intra prediction modes.

FIG. 13 illustrates an example of outside reference line for regression-based intra prediction for a current block.

FIGS. 14A-C illustrate examples of location-based multi-model design.

FIG. 15 shows using regression-based intra prediction model to generate the input of conventional planar mode.

FIG. 16 illustrates an example video encoder.

FIG. 17 illustrates portions of the video encoder that implement MSSBP.

FIG. 18 conceptually illustrates a process for using MSSBP to encode a pixel block.

FIG. 19 illustrates an example video decoder.

FIG. 20 illustrates portions of the video decoder that implement MSSBP.

FIG. 21 conceptually illustrates a process for using MSSBP to decode a pixel block.

FIG. 22 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Intra Prediction

a. Angular Intra Prediction

To capture the arbitrary edge directions presented in natural video, angular intra prediction directions are defined from 45 degrees to-135 degrees in clockwise direction. The number of directional intra modes can be 33 or 65, in addition to planar and DC modes. The directional intra prediction modes apply for all block sizes and for both luma and chroma intra predictions. The video coder may also maintain a list of most probable mode (MPM). To keep the complexity of the MPM list generation low, an intra mode coding method with 6 MPMs may be used by considering two available neighboring intra modes. The following three aspects are considered to construct the MPM list: Default intra modes, Neighboring intra modes, and Derived intra modes.

The MPM list is constructed based on intra modes of the left and above neighboring block. In addition, the first bin of the MPM index codeword is CABAC context coded. In total three contexts are used, corresponding to whether the current intra block is MRL enabled, ISP enabled, or a normal intra block. During the 6-MPM list generation process, pruning may be used to remove duplicated modes so that only unique modes are incorporated into the MPM list. For entropy coding of the 61 non-MPM modes, a Truncated Binary Code (TBC) may be used.

Several angular intra prediction modes may be adaptively replaced with wide-angle intra prediction modes for non-square blocks. The replaced modes can be signalled using the intra prediction mode indices, which are remapped to the indices of wide angular modes after parsing. The total number of wide angular intra prediction modes is still 67, and the intra mode coding method is unchanged.

b. Decoder Side Intra Mode Derivation (DIMD)

Decoder side intra mode derivation (DIMD) is an intra prediction coding tool in which two intra modes are derived from the reconstructed neighbor samples, and those two predictors are combined with the planar mode predictor with the weights derived from the gradients. The division operations in weight derivation are performed utilizing the same lookup table (LUT) based integerization scheme used by the cross-component linear model (CCLM). For example, the division operation in the orientation calculation

$$Orient = {G}_{y} / {G}_{x}$$

is computed by the following LUT-based scheme:

$$x = Floor ( Log 2 ( Gx ) )$$

$$normDiff = ( ( Gx << 4 ) >> x ) \& 15$$

$$x += ( 3 + ( normDiff != 0 ) ? 1 : 0 )$$

$$Orient = ( Gy * ( DivSigTable [ normDiff ] \vert 8 ) + ( 1 << ( x - 1 ) ) ) >> x$$

$$where$$

$$DivSigTable [ 16 ] = \{ 0 , 7 , 6 , 5 , 5 , 4 , 4 , 3 , 3 , 2 , 2 , 1 , 1 , 1 , 1 , 0 \} .$$

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

The DIMD chroma mode uses the DIMD derivation method to derive the chroma intra prediction mode of the current block based on the neighboring reconstructed Y, Cb and Cr samples in the second neighboring row and column. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

c. Template-Based Intra Mode Derivation (TIMD)

For each intra prediction mode in a MPM, The SATD between the prediction and reconstruction samples of the template is calculated. Normally, the left and above neighboring reconstructed samples are used as the template. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two TIMD selected modes are compared with a threshold, in the test the cost factor of 2 is applied as follows:

$$costMode 2 < 2 * costMode 1.$$

If this condition is true, the fusion is applied, otherwise the only model is used. Weights of the modes are computed from their SATD costs as follows:

$$weight 1 = costMode 2 / ( costMode 1 + costMode 2 )$$

$$weight 2 = 1 - weight 1$$

The division operations are conducted using the same lookup table (LUT) based integerization scheme used by the CCLM.

d. Intra Prediction Fusion

The TIMD intra prediction method may derive the predicted samples as a weighted combination of multiple predictors generated from different reference lines. In this process multiple intra predictors are generated and then fused by weighted averaging. The process of deriving the predictors to be used in the fusion process is described as follows:

For angular intra prediction modes including the single mode case of TIMD and DIMD, intra prediction is derived by weighting intra predictions obtained from multiple reference lines represented as p_{fusion}=w₀ₚₗᵢₙₑ+w₁ₚₗᵢₙₑ+1, where pₗᵢₙₑ is the intra prediction from the default reference line and pₗᵢₙₑ₊₁ is the prediction from the line above the default reference line. The weights are set as w₀=¾ and w₁=¼.

For TIMD mode with blending, pline is used for the first mode (w₀=1, w₁=0) and pₗᵢₙₑ₊₁ is used for the second mode (w₀=0, w₁=1). For DIMD mode with blending, the number of predictors selected for a weighted average is increased from 3 to 6.

Intra prediction fusion method may be applied to luma blocks when angular intra mode has non-integer slope (required reference samples interpolation) and the block size is greater than 16. Intra prediction fusion may be used with MRL and not applied for ISP coded blocks.

e. Extrapolation Intra Prediction (or EIP)

Extrapolation Intra Prediction (or EIP) is an intra prediction mode that applies a linear model or filter to generate an intra-prediction of the current block, where the EIP linear model or filter is derived by using reconstructed pixels in an extended template region neighboring the current block. The extended template region extends beyond the edges of the current block by predefined lengths (or a predefined number of pixel positions.)

In some embodiments, EIP is restricted to a block size not greater than 32×32 and intra slice only. Similar to CCCM mode, an offset value is to be removed when feeding inputs to a EIP filter.

The extrapolation filter-based intra prediction may be processed in three steps. First, min, max and offset values are obtained from a pre-defined reconstructed area. Second, the extrapolation filter coefficients are obtained from the neighboring reconstructed pixels of the current block's pre-determined template. Third, the extrapolation process generates a predicted value position by position from the top-left to bottom-right corner within the current block.

Under the EIP mode, an EIP filter or linear model is used to generate predictions for the current block based on the following calculation:

$${pred}_{( x y )} = clip ( min , max , {\sum }_{i = 0}^{14} ( {c}_{i} \times ( {t}_{( x - xoffset , y - yoffset )} - offset ) ) + offset ) \qquad Eq . ( 1 )$$

where pred_{(x,y)} is the EIP predicted value of a sample at position (x, y) in the current block. cᵢ is the i^{th} coefficient of a derived 15-tap EIP filter. Each coefficient corresponds to one of 15 sample positions (x-xoffset, y-yoffset) near the current sample. The value (may be reconstructed or predicted sample) at each of the 15 sample positions used as input to the filter is represented by t_{(x-xoffset,y-yoffset)}. Offset values are applied to the inputs taps of the EIP filter, as well as at the output of the filter. To reduce the prediction error, “min” and “max” values (from the neighboring reconstructed area) are applied to restrict the output range of each predicted value. The top-left reconstructed pixel from a pre-defined neighboring area of the current block may be used as the offset value for EIP prediction. The “min” and “max” values may be obtained from reconstructed pixels in the pre-defined reconstructed area of the current block.

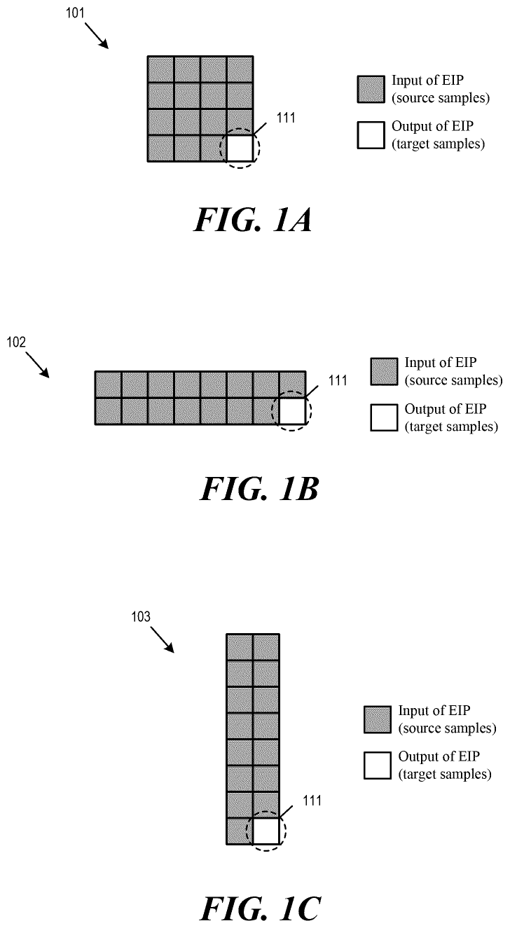

FIGS. 1A-C illustrate three types of filter kernels having fifteen inputs and generating one output that may be used by EIP. The three types of filter kernels are shown as groups of pixels in three different filter shapes. FIG. 1A illustrates a 4×4 square kernel 101. FIG. 1B illustrates an 8×2 rectangular kernel 102. FIG. 1C illustrates a 2×8 rectangular kernel 103. In each of the filter shapes, the one bottom-right sample position 111 is the output of the EIP filter (also called target sample), while the remaining 15 positions are used as the input of the EIP filter (also called source samples). The video coder may select one of several EIP filter shapes for generating a prediction of the current block.

To derive EIP filter coefficients, sample positions in the selected filter shape moves or traverses in a reconstructed area with a one-pixel step to collect input samples and output samples. In some embodiments, the input and output samples are collected from the reconstructed area by having the selected filter shape traversing a defined template region in the reconstructed area.

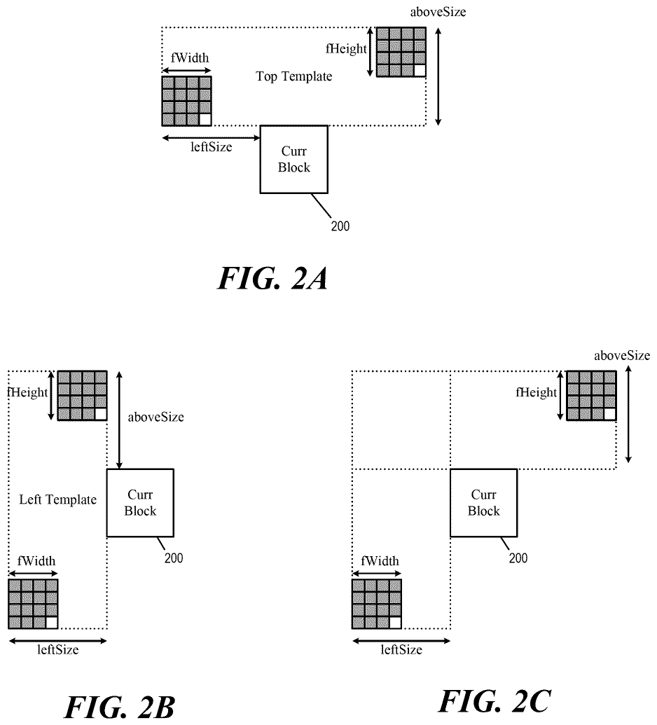

FIGS. 2A-C illustrate three types of template regions in reconstructed areas neighboring a current block 200 for providing samples to derive the EIP filter. The filter shape of FIG. 1A (4×4 square shaped) is used to illustrate the traversal of the template region for input and output samples. The size of reconstructed area depends on min (block Width, blockHeight) and the selected filter shape (fWidth, fHeight). For example, when the current block is an 8×16 block and the selected filter shape is 4×4, the aboveSize of reconstructed area is min (8, 16)+4−1=11, and the leftSize of reconstructed area is min (8, 16)+4−1=11.

FIG. 2A shows an EIP_T (or EIP_A) template region, which is a reconstructed area above the current block 200. The EIP_T template region extends beyond the left and right edges of the current block 200. For example, the EIP_T template region extends beyond the left edge of the current block 200 by leftSize and beyond the top edge of the current block 200 by aboveSize.

FIG. 2B shows an EIP_L template region, which is a reconstructed area left of the current block 200. The EIP_L template region extends beyond the top and bottom edges of the current block 200. For example, the EIP_L template region extends beyond the top edge of the current block 200 by aboveSize and left edge of the current block 200 by leftSize.

FIG. 2C shows an EIP_LT template region, which is a reconstructed area left and above the current block 200. The EIP_LT template region extend beyond top, right, left and bottom edges of the current block 200. For example, the EIP_LT template region extends beyond the top edge of the current block 200 by aboveSize and the left edge of the current block 200 by leftSize.

An auto-correlation matrix and cross-correlation vector are constructed while removing the offset value from the collected input samples and output samples. Then, the EIP coefficients are obtained or derived by the same method as in convolutional cross-component model (CCCM), which will be described in Section II.d below.

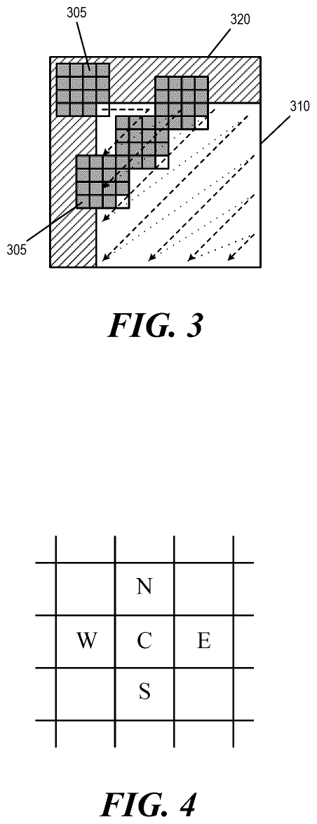

When applying the EIP model to generate the predictions for the current block, the EIP filter is applied from the top-left position to the bottom-right position by a diagonal prediction order. FIG. 3 conceptually illustrates a diagonal order according to which an EIP filter 305 is applied to generate the predictions for the current block. As illustrated, the EIP filter 305 traverses through the samples of the current block 310 to generate the predictor. The EIP filter 305 uses reconstructed samples in a region 320 neighboring the current block 310 and predicted samples within the current block 310 as inputs to the EIP filter 305.

EIP mode allows selection from three types of reconstructed areas to be used as templates for deriving the EIP model. EIP also allows selection from three types of filter kernel or filter shape. The three types of reconstructed areas as templates are shown in FIG. 2A-C above. The three types of filter kernel or filter shape are shown in FIGS. 1A-C above. In some embodiments, when the current block uses EIP mode for prediction, the encoder signals, and decoder receives, the relevant syntax elements to select a type of reconstructed area and a filter shape for the current block.

### II. Cross-Component Prediction

a. Cross Component Linear Model (CCLM)

Cross Component Linear Model (CCLM) or Linear Model (LM) mode is a cross-component prediction mode in which chroma components of a block is predicted from the collocated reconstructed luma samples by linear models. The parameters (e.g., scale and offset) of the linear model are derived from already reconstructed luma and chroma samples that are adjacent to the block. The CCLM mode makes use of inter-channel dependencies to predict the chroma samples from reconstructed luma samples. This prediction is carried out using a linear model in the form of:

$$P ( i , j ) = α \cdot {rec}_{L}^{′} ( i , j ) + β \qquad eq . ( 1 )$$

P(i, j) in eq. (1) represents the predicted chroma samples in a CU (or the predicted chroma samples of the current CU) and

$$r e {c}_{L}^{′} ( i , j )$$

represents the down-sampled reconstructed luma samples of the same CU (or the corresponding down-sampled reconstructed luma samples of the current CU).

The CCLM model parameters α (scaling parameter) and β (offset parameter) are derived based on at most four neighboring chroma samples and their corresponding down-sampled reconstructed luma samples. In LM_A mode (also denoted as LM_T mode), only the above or top-neighboring template is used to calculate the linear model coefficients. In LM_L mode (also denoted as LM_L mode), only left template is used to calculate the linear model coefficients. In LM_LA mode (also denoted as LM_LT mode), both left and above templates are used to calculate the linear model coefficients.

b. Slope Adjustment of CCLM

CCLM uses a model with 2 parameters to map luma values to chroma values. The slope parameter “a” and the bias parameter “b” define the mapping as follows:

$$chromaVal = a * lumaVal + b$$

An adjustment “u” to the slope parameter is signaled to update the model to the following form:

$$chromaVal = {a}^{′} * lumaVal + {b}^{′}$$

$$where$$

$${a}^{′} = a + u$$

$${b}^{′} = b - u * {y}_{r} .$$

With this selection the mapping function is tilted or rotated around the point with luminance value yᵣ. The average of the reference luma samples used in the model creation as yr in order to provide a meaningful modification to the model.

c. Multi-Model Linear Model (MMLM)

CCLM may be extended by adding three Multi-model LM (MMLM) modes. In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples.

d. Convolutional Cross-Component Intra-Prediction Model (CCCM)

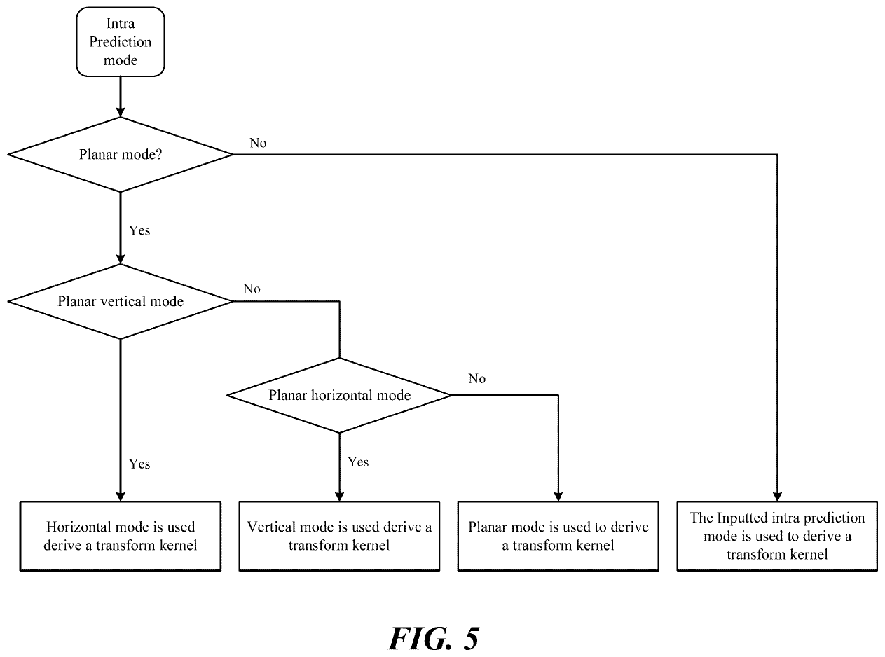

Convolutional cross-component model (CCCM) may be applied to improve the cross-component prediction performance. For some embodiment, the convolutional model has 7-tap filter having a 5-tap plus sign shape spatial component, a non-linear term and a bias term. The input to the spatial 5-tap component of the filter includes a center (C) luma sample (which is collocated with the chroma sample to be predicted) and the center luma sample's above/north (N), below/south(S), left/west (W) and right/east (E) neighbors. FIG. 4 conceptually illustrates the spatial components of a convolutional filter. The nonlinear term (denoted as P) is represented as power of two of the center luma sample C and scaled to the sample value range of the content:

$$P = ( C * C + midVal ) >> bitDepth$$

Thus, for 10-bit content the non-linear term P is calculated as:

$$P = ( C * C + 5 \; 12 ) >> 10$$

The bias term (denoted as B) represents a scalar offset between the input and output (similarly to the offset term in CCLM) and is set to middle chroma value (512 for 10-bit content). Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

The filter coefficients ci are calculated by minimising MSE between predicted and reconstructed chroma samples in the reference area. Whether to use 6 lines or 2 lines of neighbouring samples to derive the CCCM model parameters in the single model CCCM is determined by a template cost. Similarly, for the multi-model CCCM mode, the two candidates use 6 lines neighboring luma samples or luma samples collocated to the current chroma block to derive mean values which separate samples into two groups. The cost is derived by applying the candidate CCP (either 2 or 6 lines) on a template, calculating the sum of absolute difference (SAD) between CCP predicted samples and reconstructed samples in the template.

Reference area extends one PU width to the right and one PU height below the PU boundaries. Area is adjusted to include only available samples. Extensions to the area are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

An autocorrelation matrix may be calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. The fixed offsets may be removed from luma and chroma samples in each PU for each model. This is driving down the magnitudes of the values used in the model creation and allows reducing the precision needed for the fixed-point arithmetic. As a result, 16-bit decimal precision may be used instead of the 22-bit precision of the original CCCM implementation.

CCCM may be applied to predict chroma samples from reconstructed luma samples in a similar way as done by the CCLM modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

e. Gradient Linear Model

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G.

$$C = α \cdot G + β$$

The other parts of the CCLM (e.g., parameter derivation, prediction sample linear transform) are kept unchanged. In the three-parameter GLM, a chroma sample can be predicted based on both the luma sample gradients and down-sampled luma values with different parameters:

$$C = {α}_{0} \cdot G + {α}_{1} \cdot L + {α}_{2} \cdot β$$

The model parameters of the three-parameter GLM are derived from 6 rows and columns adjacent samples by the LDL decomposition based MSE minimization method as used in the CCCM.

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of 4 gradient filters for the gradient calculation.

f. Cross-Component Prediction (CCP) Merge

In some embodiments, for chroma coding, a flag is signaled to indicate whether CCP mode (including CCLM, CCCM, GLM and their variants) or non-CCP mode (conventional chroma intra prediction mode, fusion of chroma intra prediction mode) is used. If the CCP mode is selected, one more flag is signaled to indicate how to derive the CCP type and parameters, i.e., either from a CCP merge list or signaled/derived on-the-fly. a CCP merge candidate list is constructed from the spatial adjacent, spatial non-adjacent, or history-based candidates. After including these candidates, default models are further included to fill the remaining empty positions in the merge list. In order to remove redundant CCP models in the list, pruning operation is applied. After constructing the list, the CCP models in the list are reordered depending on the SAD costs, which are obtained using the neighboring template of the current block.

In some embodiments, the inherited model parameters can be from a block that is an immediate neighboring block. The models from blocks at pre-defined positions are added into a CCP merge candidate list in a pre-defined order. The CCP merge candidate list may include models from blocks at positions of spatial adjacent and non-adjacent candidates. These are the same as those defined in ECM for regular inter merge prediction candidates.

In some embodiments, a history-based table is maintained to include the recently used CCP models, and the table is reset at the beginning of each CTU row. If the current list is not full after including spatial adjacent and non-adjacent candidates, the CCP models in the history-based table are added into the list as history-based candidates.

In some embodiments, CCLM candidates with default scaling parameters are considered as default candidates, but only when the list is not full after including the spatial adjacent, spatial non-adjacent, or history-based candidates. If the current list has no candidates with the single model CCLM mode, the default scaling parameters are {0, ⅛, −⅛, 2/8, − 2/8, ⅜, −⅜, 4/8, − 4/8, ⅝, −⅝, 6/8}. Otherwise, the default scaling parameters are {0, the scaling parameter of the first CCLM candidate+ {⅛, −⅛, 2/8, − 2/8, ⅜, −⅜, 4/8, − 4/8, ⅝, −⅝, 6/8}}. The offset parameter is derived according to the default scaling parameter, average neighboring reconstructed luma sample value, and average neighboring reconstructed Cb/Cr sample value.

In some embodiments, a flag is signaled to indicate whether the CCP merge mode is applied or not. If CCP merge mode is applied, an index is signaled to indicate which candidate model is used by the current block. In addition, CCP merge mode is not allowed for the current chroma coding block when the current CU is coded by intra sub-partitions (ISP) with single tree, or the current chroma coding block size is less than or equal to 16.

g. Directional Planar Mode

Two additional planar modes (planar horizontal mode and planar vertical mode) where only the horizontal interpolation or only the vertical interpolation may be used to obtain the predicted samples. For planar horizontal mode, only the horizontal linear interpolation is performed based on the left reference sample and the top-right reference sample to predict the current sample as:

$$pred ( x , y ) = ( ( W - 1 - x ) * r e c ( - 1 , y ) + ( x + 1 ) * r e c ( W , - 1 ) + ( W >> 1 ) ) >> {log}_{2} ( W )$$

For planar vertical mode, only the vertical linear interpolation is performed based on the above reference sample and the bottom-left reference sample to predict the current sample as:

$$pred ( x , y ) = ( ( H - 1 - y ) * r e c ( x , - 1 ) + ( y + 1 ) * r e c ( - 1 , H ) + ( H >> 1 ) ) >> {log}_{2} ( H )$$

FIG. 5 shows a transform kernel selection process for planar horizontal and planar vertical mode. If an intra prediction mode of a current block is the planar vertical mode, the horizontal intra prediction mode is used to derive a transform kernel in MTS set and LFNST set. Conversely, if an intra prediction mode of a current block is the planar horizontal mode, the vertical intra prediction mode is used to derive a transform kernel in MTS set and LFNST set.

### III. Multiple Source Sample-Based Prediction (MSSBP)

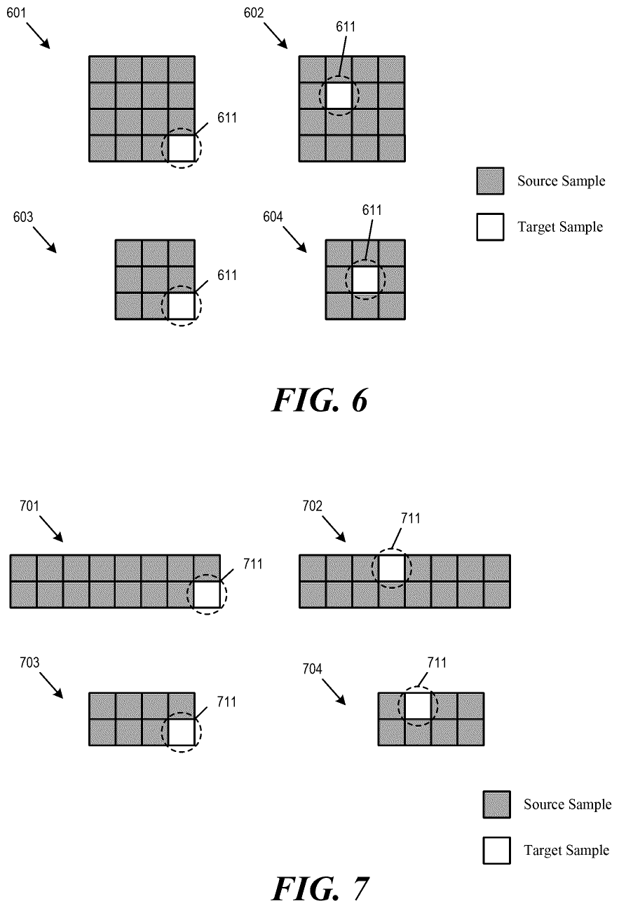

Multiple source sample-based prediction (MSSBP) is an extension of EIP as described in Section I.e above, such that EIP is a subset or specific case of MSSBP, or that EIP can also be referred to as MSSBP. The source samples used by MSSBP may include reconstructed samples, predictor samples generated by MSSBP, and/or default samples. A default sample may be a pre-defined value, or a predictor of a sample position in the current block generated by another intra prediction mode such as those described in Section I above. For MSSBP, in addition to the EIP kernel shapes described above (in Section I.e and by reference to FIGS. 1A-C), various patterns of source and target samples are defined in this section by reference to FIGS. 6-12 below. A video coder may apply any of the additional MSSBP kernel patterns when collecting the input (source) samples and output (target) samples for deriving the linear model or filter of Eq. (1). The video coder may also traverse the template region (as described by reference to FIGS. 2A-C above) based on any of the additional MSSBP kernel patterns to collect the samples for deriving the model. The video coder may also generate the MSSBP predictor for pixel positions of the current block by traversing the current block and its neighboring region (as described by reference to FIG. 3) in any of the additional MSSBP kernel patterns.

MSSBP can be applied to either luma component or chroma component. Each source samples may be a reconstructed sample, or a predictor sample generated by MSSBP. When neither the reconstructed sample nor the predictor sample is available for that source sample position, a default sample could be used. The default sample may be a predefine value such as middle value within the full range of the sample value. The default sample may also be a predictor sample generated by any of the intra prediction methods described in Section I above, such as TIMD, DIMD, CCLM, CCCM, planar mode, DC mode, angular intra prediction modes, MIP, or any other intra prediction methods.

FIG. 6 illustrates source and target samples in N×N square blocks of samples. The figure illustrates four example N×N square kernel blocks 601-604 of different sizes. As illustrated, in each N×N square block, N×N−1 source samples are used to generate the predictor for the one target (to be predicted) sample 611. The target sample 611 may be any sample within the N×N kernel block.

FIG. 7 illustrates source and target samples in M×N horizontal rectangular blocks of samples. The figure illustrates four example M×N horizontal rectangular kernel blocks 701-704 of different sizes. As illustrated, in each M×N horizontal rectangular block, M×N−1 (M>N) source samples are used to generate the predictor for the one target (to be predicted) sample 711. The target sample 711 may be any sample within the M×N kernel block.

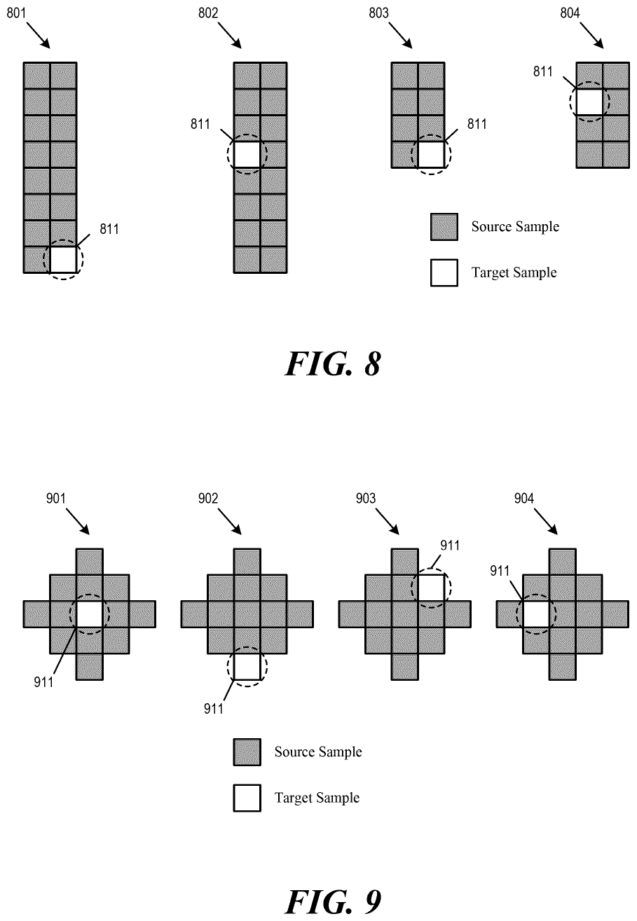

FIG. 8 illustrates source and target samples in M×N vertical rectangular blocks of samples. The figure illustrates four example M×N vertical rectangular kernel blocks 801-804 of different sizes. As illustrated, in each M×N vertical rectangular block, M×N−1 (M<N) source samples are used to generate the predictor for the one target (to be predicted) sample 811. The target sample 811 may be any sample within the M×N kernel block.

FIG. 9 illustrates source and target samples in diamond shaped kernel blocks of samples. The figure illustrates four example M-tap diamond shaped blocks of samples 901-904 of different sizes that serve as M-tap diamond shaped kernels for MSSBP. In each diamond shaped kernel, M−1 source samples are used to generate the predictor for the one target (to be predicted) sample 911. The one target sample 911 may be any sample within the M-tap diamond shaped kernel block.

In some embodiments, the target sample may be located at the next row or column of the kernel block (or adjacent to the block of source samples but not in a same row or column as the source samples). If the target sample is located at the next row of the kernel block, there are no dependencies between the predictions in the same row (the target sample does not depend on samples of that row), so the predictor generation can be performed in parallel in the horizontal direction. If the target sample is located at the next column of the kernel block, there are no dependencies between predictions in the same column (the target sample does not depend on the samples of that column), so the predictor generation can be performed in parallel in the vertical direction.

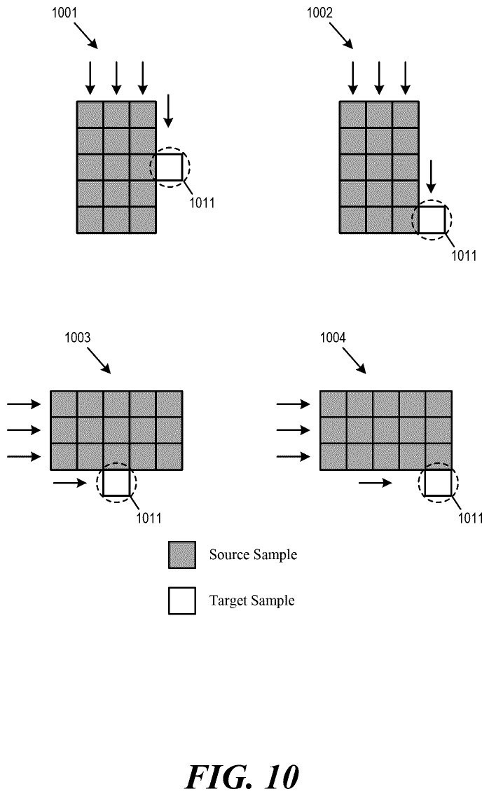

FIG. 10 illustrates when the target sample is located in a row or column that is adjacent to the kernel block. The figure illustrates four example kernel blocks 1001-1004, each kernel block including 15 source samples in a rectangle. For each example kernel block, the 15 source samples are used to generate a prediction for one target sample 1011, and the one target sample 1011 is adjacent to the example kernel block.

In the example kernel blocks 1001 and 1002, the one target sample 1011 is not in a same column as any of the source samples in the kernel, so that the predictor generation can be performed in parallel in the vertical direction (e.g., target sample can be processed in parallel with different columns in the kernel). In the example kernel blocks 1003 and 1004, the one target sample 1011 is not in a same row as any of the source samples in the kernel, so that the predictor generation can be performed in parallel in the horizontal direction (e.g., target sample can be processed in parallel with different rows in the kernel).

In some embodiments, in addition to the source samples, non-linear term of source samples may also be part of the input data of the MSSBP prediction. In some embodiments, the non-linear term is defined as the square of the samples. The horizontal and/or vertical location term may also be part of the input data of the MSBBP prediction. The location term may be the horizontal or vertical coordinate of the target sample with the origin at a pre-defined position. For example, the origin can be the upper left position of the picture, slice, CTU or current block. The predictor from other intra prediction methods such as TIMD, DIMD, CCLM, CCCM, planar mode, DC mode, angular intra prediction modes, MIP and so on may also be part of the input data of the MSSBP prediction.

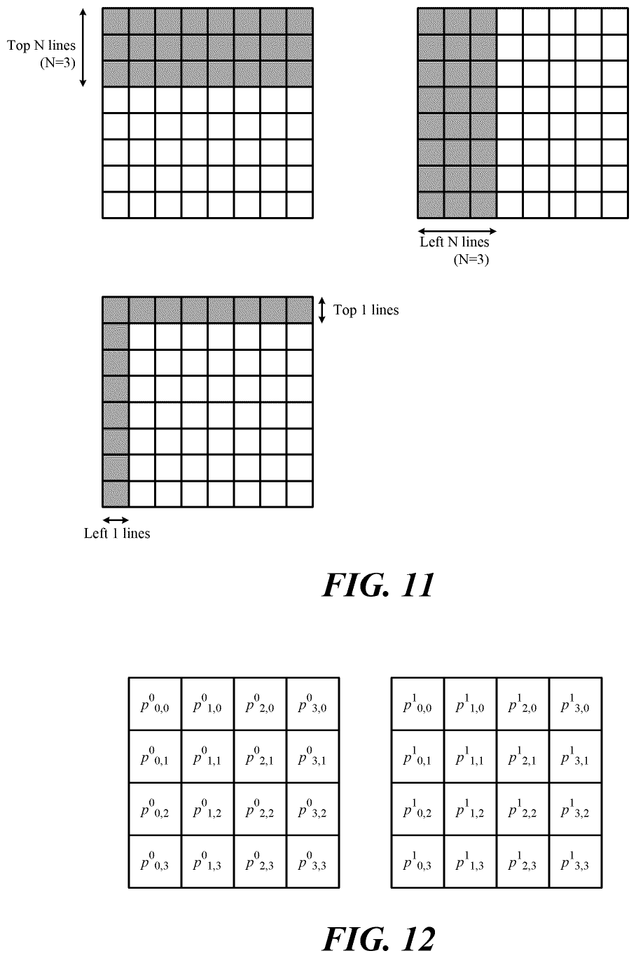

In some embodiments, the MSSBP is only applied to the boundary samples of the current block. The boundary samples are defined as the top N lines samples and/or left N lines samples, N being less than number of lines in the current block. FIG. 11 illustrates boundary samples (top and/or left N lines of samples) to which MSSBP is applied.

In some embodiments, the MSSBP are combined with the other intra mode predictors, including but not limited to those generated by other intra prediction modes such as the TIMD, DIMD, CCLM, CCCM, planar, DC, angular prediction modes, MIP, etc.

FIG. 12 illustrates combining predictors of different intra prediction modes. In the figure,

$${p}_{i , j}^{0}$$

is the predictor for the sample located at the position (i, j) generated by the

$${p}_{i , j}^{1}$$

is the predictor for the sample located at the position (i, j) generated by another intra prediction mode. The final predictor for the sample located at the position (i, j) may be generated by a linear combination of

$${p}_{i , j}^{0} and {p}_{i , j}^{1}$$

with a set of weights (W₀, W₁). These weights may be pre-defined values or values selected from a set of pre-defined weights. The weights may also be derived by a regression-based method which using neighboring samples for training. MBSSP can be applied with source samples being the reconstructed samples or the predictor samples generated by intra prediction modes such as the TIMD, DIMD, CCLM, CCCM, Planar, DC, angular prediction modes, MIP and so on.

In some embodiments, multi-model design similar to MMLM mode may be applied to MSSBP prediction. Specifically, the model selection may depend on a multi-model threshold, such that if an available sample at the position of the target sample is greater than the multi-model threshold, a first model is selected to generate the MSSBP predictor at the position of the target sample, otherwise a second model is selected to generate the predictor at the position of the target sample. The samples in the template regions may be separated into two groups according to the comparison between the sample and the multi-model threshold. The first model and the second model may be models that are derived from samples of different groups, models derived from samples of different template regions, or models derived for different kernel block shapes.

The multi-model threshold may be the average of neighboring reconstructed samples neighboring the current block in some embodiments. If the source sample of the MSSBP predictor is the predictor sample generated by another intra prediction mode, the model selection may depend on the result of the comparison between the multi-model threshold and the source sample (predicted by the other intra prediction mode) at the position of target sample.

If a source samples of MSSBP predictor is a reconstructed sample or a predictor sample generated by MSSBP, there is no available sample at the position of target sample, so the model selection may depend on the comparison between the multi-model threshold and a predicted source sample (as the available sample) at the position of target sample. The predicted source sample at the position of the target sample may be one of the source samples in the kernel. Or the predicted source sample at the position of the target sample may be derived by its neighboring source samples. For example, the predicted source sample may be the average of its above source sample and its left source sample, or it could be the average of all source samples in the kernel.

The model selection may also depend on the position of the target sample. For example, if the horizontal position of the target sample relative to the top-left corner of the current block is larger than the vertical position of the target sample relative to the top-left corner of the current block, a first model is used. Otherwise, a second model is used.

### IV. Regression-Based Intra Prediction

In some embodiments, regression-based intra prediction mode may be one of the intra luma mode, and the regression-based intra prediction luma model could be used to generate the intra luma predictor. In some embodiments, the input of the proposed regression-based intra prediction model could contain one or more reference terms. The reference term may be a neighboring reconstructed sample determined by the current sample position. For example, some definitions of reference terms RefT and RefL are shown below, where (x, y) is the position of current sample:

$$RefT ( x ) = rec ( x , - 1 ) \qquad ( 13 )$$

$$RefL ( y ) = rec ( - 1 , y ) \qquad ( 14 )$$

In some embodiments, the reference terms in the proposed regression-based intra prediction model could be a neighboring reconstructed sample from the other color channel, which is also determined by the current sample position. If the color format is not YUV444, the sample position should be transformed into the other color channel.

In some embodiment, the input of the proposed regression-based intra prediction model could contain one or more position terms. The position term could be the vertical and horizontal relative position of current sample, which are calculated with respect to the top-left coordinates of the current block. For example, some definitions of position terms X and Y are shown below:

$$X = x - {x}_{block} \qquad ( 15 )$$

$$Y = y - {y}_{block} \qquad ( 16 )$$

In some embodiments, the position terms in the proposed regression-based intra prediction model could be normalized by the current block size. For example, some definitions of position terms X and Y are shown below:

$$X = \frac{x - {x}_{block}}{{w}_{block}} \qquad ( 17 )$$

$$Y = \frac{y - {y}_{block}}{{h}_{block}} \qquad ( 18 )$$

In some embodiments, the position terms in the proposed regression-based intra prediction model could be normalized by the current block size, and then could be scaled by a predefined value s. For example, some definitions of position terms X and Y are shown below:

$$X = \frac{x - {x}_{block}}{{w}_{block}} \times s \qquad ( 19 )$$

$$Y = \frac{y - {y}_{block}}{{h}_{block}} \times s \qquad ( 20 )$$

In some embodiments, the input of the proposed regression-based intra prediction model could contain one or more nonlinear reference terms, where the nonlinear operation is the same as the nonlinear term in CCCM.

In some embodiment, the input of the proposed regression-based intra prediction model could contain one or more nonlinear position terms, where the nonlinear operation is the same as the nonlinear term in CCCM.

In some embodiments, the input of the proposed regression-based intra prediction model could contain one or more position interaction terms. This term could be an interaction between the horizontal relative position and the vertical relative position. For example, the definition of the position interaction terms is shown below:

$${I}_{pos} = XY \qquad ( 21 )$$

In some embodiments, the input of the proposed regression-based intra prediction model could contain one or more reference-position interaction terms. This term could be an interaction between the neighboring reconstructed sample determined by the current sample position and the vertical or horizontal relative position of current sample. For example, some definitions of the reference-position interaction terms are shown below:

$${I}_{ref , pos} = RefT ( x ) X \qquad ( 22 )$$

$${I}_{ref , pos} = RefT ( x ) Y \qquad ( 23 )$$

$${I}_{ref , pos} = RefL ( x ) X \qquad ( 24 )$$

$${I}_{ref , pos} = RefL ( x ) Y \qquad ( 25 )$$

In some embodiments, the input of the proposed regression-based intra prediction model could contain one bias terms, where the definition of bias term is the same as the definition of bias term in CCCM.

In some embodiments, the neighboring reference samples could be directly used for the proposed regression-based intra prediction mode.

In some embodiments, the smoothed neighboring reference samples could be used for the proposed regression-based intra prediction mode. The smoothing filter could be a 3-tap [1, 2, 1] filter which is the same as the smoothing filter in VVC.

In some embodiments, the input of the proposed regression-based intra prediction luma model could contain two reference terms from both the above reference samples and the left reference samples and one bias term, and each item has a separate parameter. An example is shown below:

$${pred}_{Y} ( x , y ) = {c}_{0} {RefT}_{Y} ( x ) + {c}_{1} {RefL}_{Y} ( y ) + {c}_{2} B \qquad ( 26 )$$

In some embodiments, the input of the proposed regression-based intra prediction luma model could contain two reference terms from both the above reference samples and the left reference samples, two position terms and one bias term, and each item has a separate parameter. An example is shown below:

$${pred}_{Y} ( x , y ) = {c}_{0} {RefT}_{Y} ( x ) + {c}_{1} {RefL}_{Y} ( y ) + {c}_{2} X + {c}_{3} Y + {c}_{4} B \qquad ( 27 )$$

In some embodiments, when deriving the parameter of the proposed regression-based intra prediction model, one or multiple lines of the above reconstructed samples and the left reconstructed samples could be used for the regression process.

In some embodiments, when deriving the parameter of the proposed regression-based intra prediction model, LDL decomposition method could be used to solve the correlation matrix equation to obtain an optimal parameter set of the proposed regression-based intra prediction model.

In some embodiments, when deriving the parameter of the proposed regression-based intra prediction model, Gaussian elimination method could be used to solve the correlation matrix equation to obtain a optimal parameter set of the proposed regression-based intra prediction model.

a. Syntax of Regression-Based Intra Prediction

In some embodiment, the regression-based intra prediction mode may be a sub-mode of Planar mode, if the current block is coded by Planar mode, one flag could be signaled for indicating whether the proposed regression-based intra prediction mode is used or not. In some embodiments, the regression-based intra prediction mode could be a sub-mode of DC mode, if the current block is coded by DC mode, one flag could be signaled for indicating whether the proposed regression-based intra prediction mode is used or not. In some embodiments, the regression-based intra prediction mode may be a sub-mode of HOR mode or VER mode, if the current block is coded by HOR mode or VER mode, one flag could be signaled for indicating whether the proposed regression-based intra prediction mode is used or not.

In some embodiments, an on/off flag of the proposed regression-based intra prediction may be signaled before a DIMD on/off flag. In some embodiments, the on/off flag of the proposed regression-based intra prediction could be signaled before the TIMD on/off flag. In some embodiments, the on/off flag of the proposed regression-based intra prediction may be signaled f before the MIP on/off flag. In some embodiment, the on/off flag of the proposed regression-based intra prediction may be signaled before the MPM related syntax.

b. Using Outside Reference Line for Regression-Based Intra Prediction

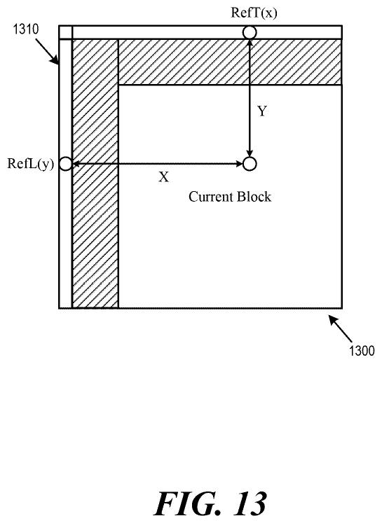

To keep both the template and the current block inside the reference line, an outside reference line may be selected for deriving the regression-based model. FIG. 13 illustrates an example of outside reference line 1310 for regression-based intra prediction for a current block 1300. In some embodiments, N neighboring reconstructed lines closest to the current block is the template region, and the (N+1)th neighboring reconstructed line is the reference line, which is used for the input of the regression-based model. In some embodiments, the number of N could be a pre-defined value. In another embodiment, the number of N could be determined by one explicitly signaled syntax.

In some embodiments, the reference line used for deriving the regression-based model is the same as that used for generating the predictor of current block. In some embodiments, the reference line used for deriving the regression-based model is different than that used for generating the predictor of current block.

c. Multi-Model Design for Regression-Based Intra Prediction

The multi-model design has been used for the intra chroma cross-component prediction, and the mean value of neighboring reconstructed luma samples is used as the threshold. The model selection will depend on the result of comparing the collocated reconstructed luma sample with the threshold. However, there is no collocated reconstructed sample in the regression-based intra prediction. Some embodiments provide a location-based multi-model method.

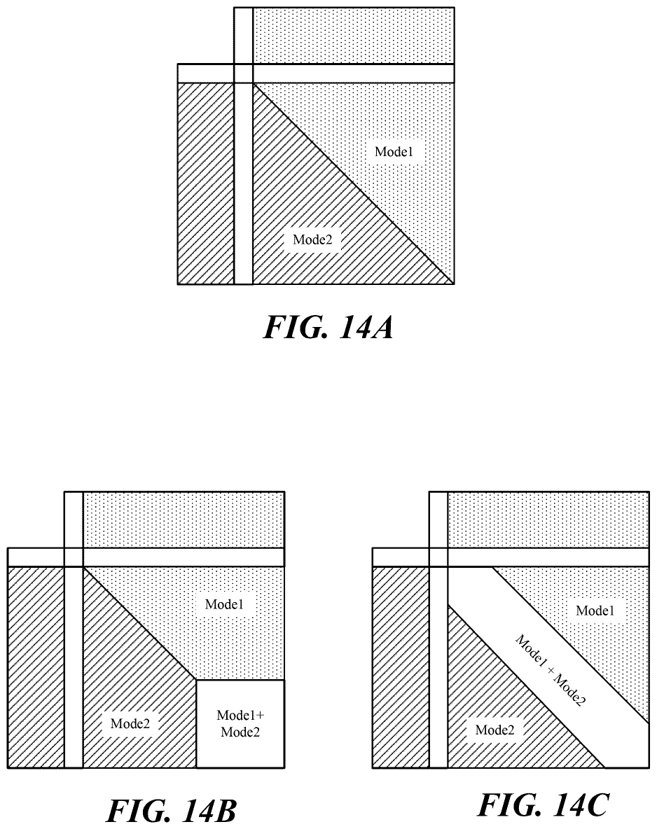

In some embodiments, which model is used to generate the prediction for the current sample could be determined by comparing its horizontal and vertical positions relative to the top-left corner of the current block. If the horizontal position is larger than (or equal to) the vertical position, the first model is used to generate the prediction. Otherwise, the second model is used to generate the prediction. FIGS. 14A-C illustrate examples of location-based multi-model design.

In some embodiments, the first model uses the above template for deriving the regression-based model, and the second model uses the left template for deriving the regression-based model as illustrated in FIG. 14A.

In some embodiments, some of the samples may use both the first model and the second model to generate its final prediction, and the fusion weight could be predefined weights, such as {0.5, 0.5}, {0.25, 0.75}, and so on, or location-dependent weights. For one example, if the horizontal position is larger than a pre-defined threshold or the vertical position is larger than a pre-defined threshold, both the first model and the second model are used as illustrated in FIG. 14B.

For another example, if the difference of the horizontal position and the vertical position is smaller than a pre-defined threshold, both the first model and the second model are used as illustrated in FIG. 14C. In another example, the predefined weights are derived according to one or the combination of CU width, CU height, the number of samples used for deriving the regression-based model, and regression error of regression-based models.

d. Combination with Conventional Intra Planar Mode

To further improve the coding efficiency of intra planar mode, in some embodiments, some of the inputs of conventional intra planar mode are replaced with predicted samples derived from a regression-based model.

In some embodiments, the regression-based model may be a regression-based intra prediction model using neighboring reconstructed samples as model inputs. In some embodiments, if the current block is a chroma block, the regression-based model may be a cross-component model using collocated luma reconstructed samples as model inputs.

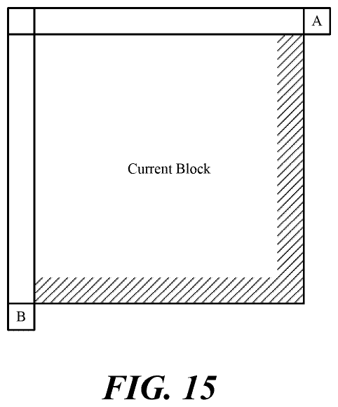

FIG. 15 shows using regression-based intra prediction model to generate the input of conventional planar mode. In conventional intra planar mode, the sample A in the figure is used for horizontal interpolation, and the sample B in the figure is used for vertical interpolation. In some embodiments, the sample A and/or the sample B is replaced with a predicted sample generated by a regression-based model.

In some embodiments, the samples in the right column of the current block are generated by the regression-based model, and then they are used for horizontal interpolation. The samples in the bottom row of the current block are also generated by the regression-based model, and then they are used for vertical interpolation. In some embodiments, the samples in the right column of the current block are generated by the first regression-based model, and then they are used for horizontal interpolation. The samples in the bottom row of the current block are generated by the second regression-based model, and then they are used for vertical interpolation.

In some embodiments, the horizontal interpolation results based on the regression-based model predicted sample and the vertical interpolation result based on the regression-based model predicted sample could be further fused into a final predicter, and the fusion weight could be equal weights {0.5, 0.5}, a pre-defined weight set, a weight set implicitly or explicitly selected from a pre-defined table of weight set, or derived by a regression-based method.

In some embodiments, the horizontal interpolation results based on the regression-based model predicted sample may be used for horizontal directional planar mode, and the vertical interpolation results based on the regression-based model predicted sample may be used for vertical directional planar mode.

In some embodiment, the (regression-based intra prediction model as input to generate the input of conventional planar mode) method described in this section may be an intra coding tool, for which a flag may be signaled at block level to indicate whether it is used or not. In some embodiments, the method may be a sub-mode of the conventional planar mode and/or the direction planar mode, and if the conventional planar mode or the direction planar mode is selected, a flag is signaled to indicate whether the regression-based intra prediction model method is used or not. In some embodiments, the conventional planar mode and/or the direction planar mode may be replaced by the regression-based intra prediction model method.

In some embodiments, the methods described above are allowed with some CU size constraint. The CU size could be the width of CU, the height of CU or the area of CU. For example, only when the area of CU is greater than 64, the regression-based intra prediction is allowed. In another example, only when the width of CU and the height of CU are both greater than 8, the multi-model regression-based intra prediction is allowed.

In some embodiments, the proposed method in the above is allowed with some constraint of the number of samples in the template region. For example, only when the number of samples in the template region is greater than 64, the regression-based intra prediction is allowed. In another example, only when the number of samples in the template region is greater than 128, the multi-model regression-based intra prediction is allowed.

Any of the foregoing proposed methods could be applied independently or jointly. Moreover, any of the foregoing proposed methods can be implemented in encoders and/or decoders. For example, any of the proposed methods can be implemented in inter prediction module of an encoder and/or a decoder. Alternatively, any of the proposed methods can be implemented as a circuit coupled to inter prediction module of the encoder and/or the decoder.

### V. Example Video Encoder

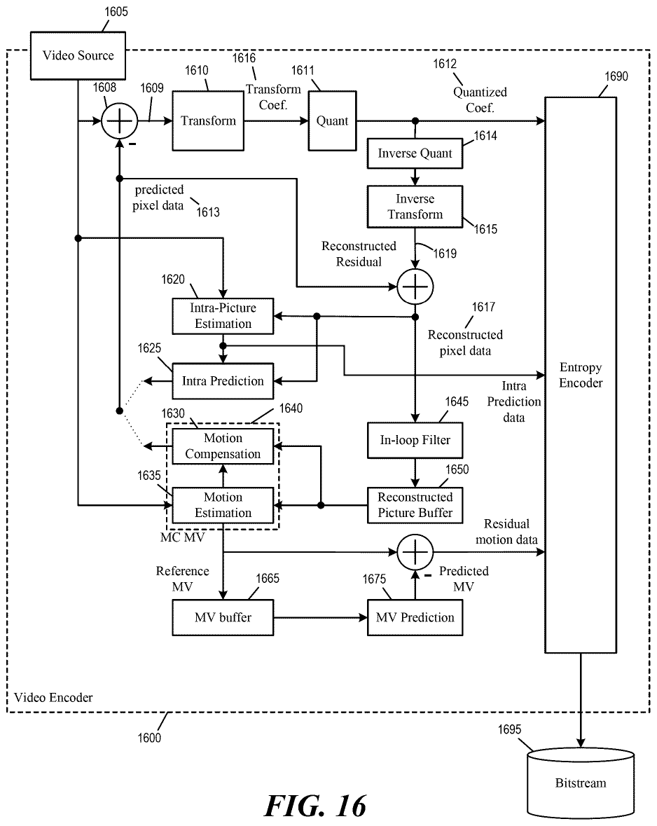

FIG. 16 illustrates an example video encoder 1600. As illustrated, the video encoder 1600 receives input video signal from a video source 1605 and encodes the signal into bitstream 1695. The video encoder 1600 has several components or modules for encoding the signal from the video source 1605, at least including some components selected from a transform module 1610, a quantization module 1611, an inverse quantization module 1614, an inverse transform module 1615, an intra-picture estimation module 1620, an intra-prediction module 1625, a motion compensation module 1630, a motion estimation module 1635, an in-loop filter 1645, a reconstructed picture buffer 1650, a MV buffer 1665, and a MV prediction module 1675, and an entropy encoder 1690. The motion compensation module 1630 and the motion estimation module 1635 are part of an inter-prediction module 1640.

In some embodiments, the modules 1610-1690 are modules of software instructions being executed by one or more processing units (e.g., a processor) of a computing device or electronic apparatus. In some embodiments, the modules 1610-1690 are modules of hardware circuits implemented by one or more integrated circuits (ICs) of an electronic apparatus. Though the modules 1610-1690 are illustrated as being separate modules, some of the modules can be combined into a single module.

The video source 1605 provides a raw video signal that presents pixel data of each video frame without compression. A subtractor 1608 computes the difference between the raw video pixel data of the video source 1605 and the predicted pixel data 1613 from the motion compensation module 1630 or intra-prediction module 1625 as prediction residual 1609. The transform module 1610 converts the difference (or the residual pixel data or residual signal 1609) into transform coefficients (e.g., by performing Discrete Cosine Transform, or DCT). The quantization module 1611 quantizes the transform coefficients into quantized data (or quantized coefficients) 1612, which is encoded into the bitstream 1695 by the entropy encoder 1690.

The inverse quantization module 1614 de-quantizes the quantized data (or quantized coefficients) 1612 to obtain transform coefficients, and the inverse transform module 1615 performs inverse transform on the transform coefficients to produce reconstructed residual 1619. The reconstructed residual 1619 is added with the predicted pixel data 1613 to produce reconstructed pixel data 1617. In some embodiments, the reconstructed pixel data 1617 is temporarily stored in a line buffer (not illustrated) for intra-picture prediction and spatial MV prediction. The reconstructed pixels are filtered by the in-loop filter 1645 and stored in the reconstructed picture buffer 1650. In some embodiments, the reconstructed picture buffer 1650 is a storage external to the video encoder 1600. In some embodiments, the reconstructed picture buffer 1650 is a storage internal to the video encoder 1600.

The intra-picture estimation module 1620 performs intra-prediction based on the reconstructed pixel data 1617 to produce intra prediction data. The intra-prediction data is provided to the entropy encoder 1690 to be encoded into bitstream 1695. The intra-prediction data is also used by the intra-prediction module 1625 to produce the predicted pixel data 1613.

The motion estimation module 1635 performs inter-prediction by producing MVs to reference pixel data of previously decoded frames stored in the reconstructed picture buffer 1650. These MVs are provided to the motion compensation module 1630 to produce predicted pixel data.

Instead of encoding the complete actual MVs in the bitstream, the video encoder 1600 uses MV prediction to generate predicted MVs, and the difference between the MVs used for motion compensation and the predicted MVs is encoded as residual motion data and stored in the bitstream 1695.

The MV prediction module 1675 generates the predicted MVs based on reference MVs that were generated for encoding previously video frames, i.e., the motion compensation MVs that were used to perform motion compensation. The MV prediction module 1675 retrieves reference MVs from previous video frames from the MV buffer 1665. The video encoder 1600 stores the MVs generated for the current video frame in the MV buffer 1665 as reference MVs for generating predicted MVs.

The MV prediction module 1675 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1695 by the entropy encoder 1690.

The entropy encoder 1690 encodes various parameters and data into the bitstream 1695 by using entropy-coding techniques such as context-adaptive binary arithmetic coding (CABAC) or Huffman encoding. The entropy encoder 1690 encodes various header elements, flags, along with the quantized transform coefficients 1612, and the residual motion data as syntax elements into the bitstream 1695. The bitstream 1695 is in turn stored in a storage device or transmitted to a decoder over a communications medium such as a network.

The in-loop filter 1645 performs filtering or smoothing operations on the reconstructed pixel data 1617 to reduce the artifacts of coding, particularly at boundaries of pixel blocks. In some embodiments, the filtering or smoothing operations performed by the in-loop filter 1645 include deblock filter (DBF), sample adaptive offset (SAO), and/or adaptive loop filter (ALF). In some embodiments, luma mapping chroma scaling (LMCS) is performed before the loop filters.

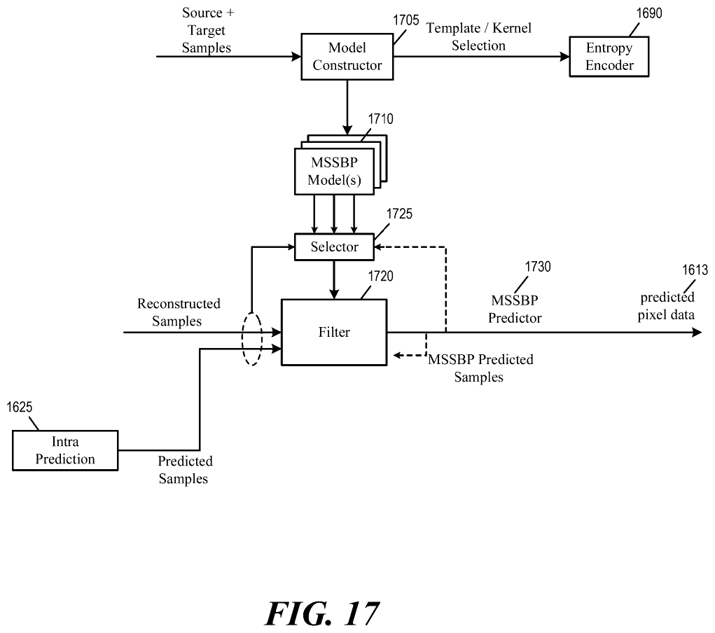

FIG. 17 illustrates portions of the video encoder 1600 that implement MSSBP. A MSSBP model constructor 1705 may retrieve source samples and target samples for various sample positions. The source samples may be reconstructed samples (from before the in-loop filter or from the reconstructed picture buffer 1650) in template regions that are defined by a selected template region type, e.g., EIP_T, EIP_L, EIP_LT as described by reference to FIG. 2 above. The retrieved template samples may be used to derive one or more MSSBP models 1710 by regression according to a selected filter kernel shape. Each MSSBP model 1710 is a filter that includes a set of coefficients for a set of filter taps (e.g. 15 taps). Example filter kernel shapes are described by reference to FIGS. 1 and 6-10 above. The selection of the template region and of the filter shape are provided to the entropy encoder 1690 to be signaled in the bitstream 1695.

In some embodiments, multiple MSSBP models are used to implement multi-model prediction. A selector 1725 may select different MSSBP models for different target positions of the current block. Such a selection for a target position may be based on a model threshold (that may be an average of neighboring samples) or the availability of predicted or reconstructed samples for the target position, as described in Section III above.

A filter 1720 applies the selected MSSBP model (by e.g., calculating Eq. (1) described in Section I.e) to generate a prediction for each target position in the current block. The filter 1720 may use the target position's neighboring reconstructed samples, MSSBP predicted samples (provided by the MSSBP predictor 1725), or predicted samples (provided by the intra prediction module 1625) as filter input, at source sample positions specified by the selected filter shape. The filter may traverse the current block to generate the samples of the predictor according to a diagonal pattern as described by reference to FIG. 3 above. The predictions for the different target positions of the current block are provided as the MSSBP predictor 1730 and used as the predicted pixel data 1613.

For a filter shape in which the target position is independent of any row (or column) of the source sample positions as shown in FIG. 10, the encoder may process the different rows (or columns) in parallel.

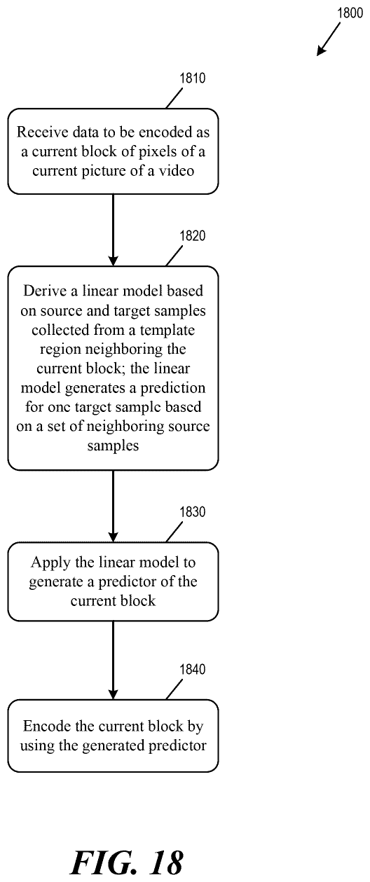

FIG. 18 conceptually illustrates a process 1800 for using MSSBP to encode a pixel block. In some embodiments, one or more processing units (e.g., a processor) of a computing device implementing the encoder 1600 performs the process 1800 by executing instructions stored in a computer readable medium. In some embodiments, an electronic apparatus implementing the encoder 1600 performs the process 1800.

The encoder receives (at block 1810) data to be encoded as a current block of pixels in a current picture. The encoder derives (at block 1820) a linear model based on source and target samples collected from a template region neighboring the current block. The linear model generates a prediction for one target sample based on a set of neighboring source samples. The target sample may be in a next column or a next row to the set of source samples (or adjacent to the set of source samples but not in a same row as any of the set of source samples or not in a same column as any of the set of source samples). This allows the target sample to be processed in parallel with the set of source samples.

The encoder applies (at block 1830) the linear model to generate a predictor of the current block by traversing the linear model through each target position of the current block. The encoder may use reconstructed samples, predicted samples, or predefined values, as input to the linear model. The predicted samples as input may be predicted by an intra prediction mode (an angular directional mode, DC mode, planar, mode, determined by TIMD or by DIMD, etc.), or predicted by the linear model for another pixel position.

In some embodiments, the linear model is applied to generate prediction for only a subset of the pixel positions of the current block. The subset of pixel positions may be in M rows closest to the top boundary of the current block and/or N columns closest to the left boundary of the current block, where M and N are positive integer values. In some embodiments, the video encoder generates a first predictor by using the linear model and a second predictor by using an intra prediction mode, and the current block is encoded by combining the first and second predictors.

In some embodiments, for each sample position of the current block, one linear model is selected to be applied to generate a predictor for the sample position, where the linear model is selected from a plurality of linear models based on a comparison between an available sample for the sample position and a multi-model threshold. The multi-model threshold may be an average of reconstructed samples neighboring the current block. The available sample may be a prediction generated by an intra-prediction mode for the sample position. The available sample may also be a reconstructed sample or a predicted sample of a neighboring position.

The encoder encodes (at block 1840) the current block by using the generated predictor to produce prediction residuals.

### VI. Example Video Decoder

In some embodiments, an encoder may signal (or generate) one or more syntax element in a bitstream, such that a decoder may parse said one or more syntax element from the bitstream.

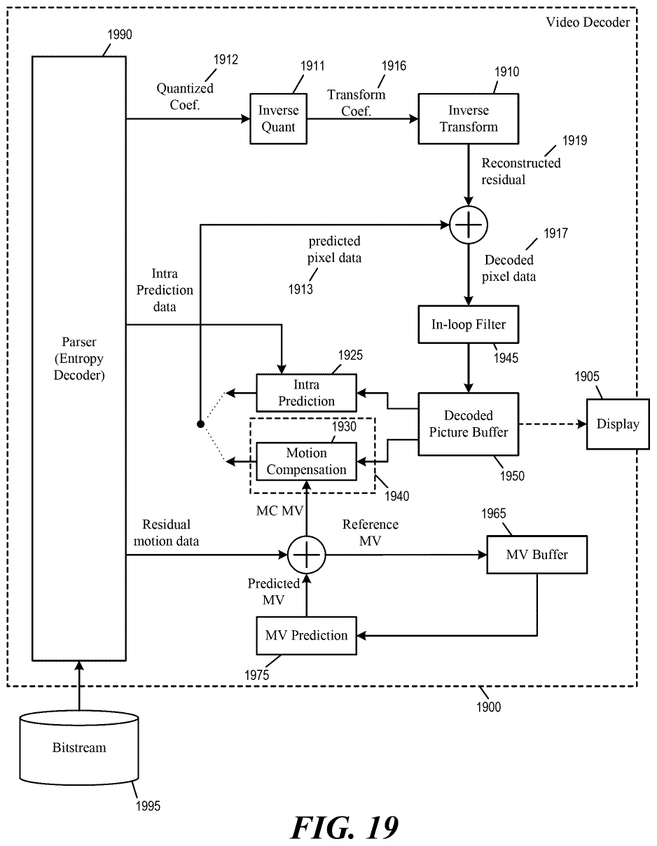

FIG. 19 illustrates an example video decoder 1900. As illustrated, the video decoder 1900 is an image-decoding or video-decoding circuit that receives a bitstream 1995 and decodes the content of the bitstream into pixel data of video frames for display. The video decoder 1900 has several components or modules for decoding the bitstream 1995, including some components selected from an inverse quantization module 1911, an inverse transform module 1910, an intra-prediction module 1925, a motion compensation module 1930, an in-loop filter 1945, a decoded picture buffer 1950, a MV buffer 1965, a MV prediction module 1975, and a parser 1990. The motion compensation module 1930 is part of an inter-prediction module 1940.

In some embodiments, the modules 1910-1990 are modules of software instructions being executed by one or more processing units (e.g., a processor) of a computing device. In some embodiments, the modules 1910-1990 are modules of hardware circuits implemented by one or more ICs of an electronic apparatus. Though the modules 1910-1990 are illustrated as being separate modules, some of the modules can be combined into a single module.

The parser 1990 (or entropy decoder) receives the bitstream 1995 and performs initial parsing according to the syntax defined by a video-coding or image-coding standard. The parsed syntax element includes various header elements, flags, as well as quantized data (or quantized coefficients) 1912. The parser 1990 parses out the various syntax elements by using entropy-coding techniques such as context-adaptive binary arithmetic coding (CABAC) or Huffman encoding.

The inverse quantization module 1911 de-quantizes the quantized data (or quantized coefficients) 1912 to obtain transform coefficients, and the inverse transform module 1910 performs inverse transform on the transform coefficients 1916 to produce reconstructed residual signal 1919. The reconstructed residual signal 1919 is added with predicted pixel data 1913 from the intra-prediction module 1925 or the motion compensation module 1930 to produce decoded pixel data 1917. The decoded pixels data are filtered by the in-loop filter 1945 and stored in the decoded picture buffer 1950. In some embodiments, the decoded picture buffer 1950 is a storage external to the video decoder 1900. In some embodiments, the decoded picture buffer 1950 is a storage internal to the video decoder 1900.

The intra-prediction module 1925 receives intra-prediction data from bitstream 1995 and according to which, produces the predicted pixel data 1913 from the decoded pixel data 1917 stored in the decoded picture buffer 1950. In some embodiments, the decoded pixel data 1917 is also stored in a line buffer (not illustrated) for intra-picture prediction and spatial MV prediction.

In some embodiments, the content of the decoded picture buffer 1950 is used for display. A display device 1905 either retrieves the content of the decoded picture buffer 1950 for display directly, or retrieves the content of the decoded picture buffer to a display buffer. In some embodiments, the display device receives pixel values from the decoded picture buffer 1950 through a pixel transport.

The motion compensation module 1930 produces predicted pixel data 1913 from the decoded pixel data 1917 stored in the decoded picture buffer 1950 according to motion compensation MVs (MC MVs). These motion compensation MVs are decoded by adding the residual motion data received from the bitstream 1995 with predicted MVs received from the MV prediction module 1975.

The MV prediction module 1975 generates the predicted MVs based on reference MVs that were generated for decoding previous video frames, e.g., the motion compensation MVs that were used to perform motion compensation. The MV prediction module 1975 retrieves the reference MVs of previous video frames from the MV buffer 1965. The video decoder 1900 stores the motion compensation MVs generated for decoding the current video frame in the MV buffer 1965 as reference MVs for producing predicted MVs.

The in-loop filter 1945 performs filtering or smoothing operations on the decoded pixel data 1917 to reduce the artifacts of coding, particularly at boundaries of pixel blocks. In some embodiments, the filtering or smoothing operations performed by the in-loop filter 1945 include deblock filter (DBF), sample adaptive offset (SAO), and/or adaptive loop filter (ALF). In some embodiments, luma mapping chroma scaling (LMCS) is performed before the loop filters.

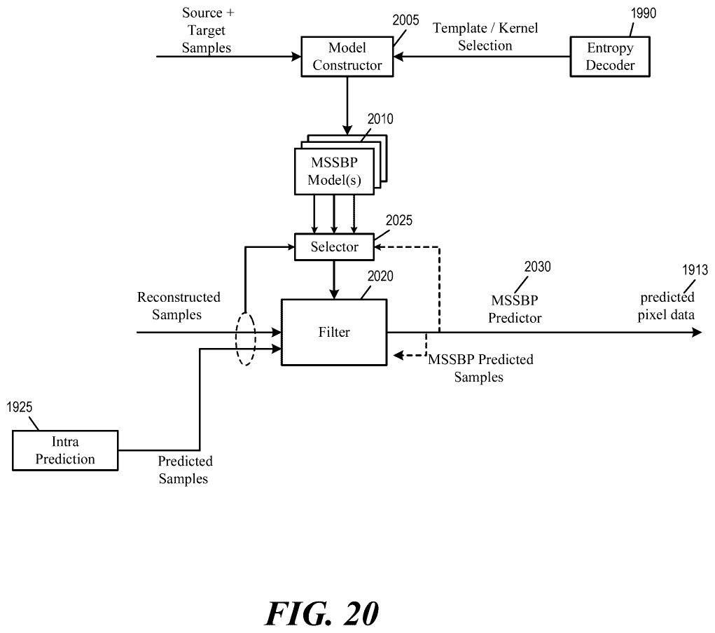

FIG. 20 illustrates portions of the video decoder 1900 that implement MSSBP. A MSSBP model constructor 2005 may retrieve source samples and target samples for various sample positions. The source samples may be reconstructed samples (from before the in-loop filter or from the decoded picture buffer 1950) in template regions that are defined by a selected template region type, e.g., EIP_T, EIP_L, EIP_LT as described by reference to FIG. 2 above. The retrieved template samples may be used to derive one or more MSSBP models 2010 by regression according to a selected filter kernel shape. Each MSSBP model 2010 is a filter that includes a set of coefficients for a set of filter taps (e.g. 15 taps). Example filter kernel shapes are described by reference to FIGS. 1 and 6-10 above. The selection of the template region and of the filter shape may be provided by the entropy decoder 1990 by parsing the bitstream 1995.

In some embodiments, multiple MSSBP models are used to implement multi-model prediction. A selector 2025 may select different MSSBP models for different target positions of the current block. Such a selection for a target position may be based on a model threshold (that may be an average of neighboring samples) or the availability of predicted or reconstructed samples for the target position, as described in Section III above.

A filter 2020 applies the selected MSSBP model (by calculating Eq. (1) described in Section I.e) to generate a prediction for each target position in the current block. The filter 2020 may use the target position's neighboring reconstructed samples, MSSBP predicted samples (provided by the MSSBP predictor 2030), or predicted samples (provided by the intra prediction module 1925) as filter input at source sample positions specified by the selected filter shape. The filter may traverse the current block to generate the samples of the predictor according to a diagonal pattern as described by reference to FIG. 3 above. The predictions for the different target positions of the current block are provided as the MSSBP predictor 2030 and used as the predicted pixel data 1913.

For a filter shape in which the target position is independent of any row (or column) of the source sample positions as shown in FIG. 10, the decoder may process the different rows (or columns) in parallel.

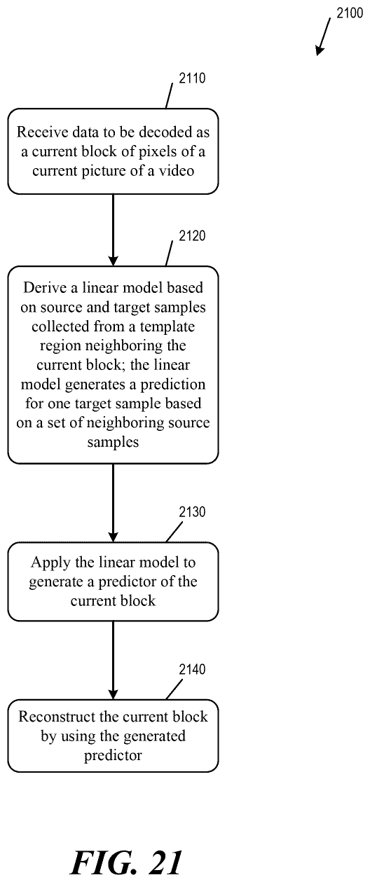

FIG. 21 conceptually illustrates a process 2100 for using MSSBP to decode a pixel block. In some embodiments, one or more processing units (e.g., a processor) of a computing device implementing the decoder 1900 performs the process 2100 by executing instructions stored in a computer readable medium. In some embodiments, an electronic apparatus implementing the decoder 1900 performs the process 2100.

The decoder receives (at block 2110) data to be decoded as a current block of pixels in a current picture. The decoder derives (at block 2120) a linear model based on source and target examples collected from a template region neighboring the current block. The linear model generates a prediction for one target sample based on a set of neighboring source samples. The target sample may be in a next column or a next row to the set of source samples (or adjacent to the set of source samples but not in a same row as any of the set of source samples or not in a same column as any of the set of source samples). This allows the target sample to be processed in parallel with the set of source samples.

The decoder applies (at block 2130) the linear model to generate a predictor of the current block by traversing the linear model through each position of the current block. The decoder may use reconstructed samples, predicted samples, or predefined values, as input to the linear model. The predicted samples as input may be predicted by an intra prediction mode (an angular directional mode, DC mode, planar, mode, determined by TIMD or by DIMD, etc.), or predicted by the linear model for another pixel position.

In some embodiments, the linear model is applied to generate prediction for only a subset of the pixel positions of the current block. The subset of pixel positions may be in M rows closest to the top boundary of the current block or N columns closest to the left boundary of the current block, where M and N are positive integer values. In some embodiments, the video decoder generates a first predictor by using the linear model and a second predictor by using an intra prediction mode, and the current block is decoded by combining the first and second predictors.

In some embodiments, for each sample position of the current block, one linear model is selected to be applied to generate a predictor for the sample position, where the linear model is selected from a plurality of linear models based on a comparison between an available sample for the sample position and a multi-model threshold. The multi-model threshold may be an average of reconstructed samples neighboring the current block. The available sample may be a prediction generated by an intra-prediction mode for the sample position. The available sample may also be a reconstructed sample or a predicted sample of a neighboring position.

The decoder reconstructs (at block 2140) the current block by using the generated predictor. The decoder may then provide the reconstructed current block for display as part of the reconstructed current picture.

### VII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

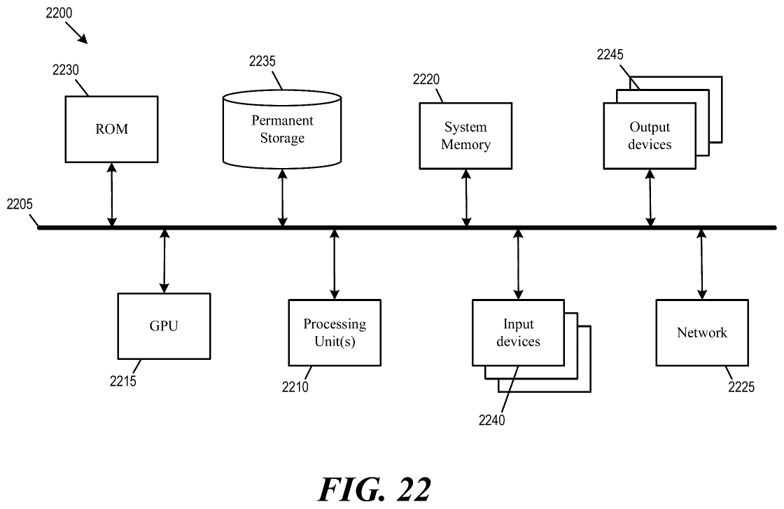

FIG. 22 conceptually illustrates an electronic system 2200 with which some embodiments of the present disclosure are implemented. The electronic system 2200 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 2200 includes a bus 2205, processing unit(s) 2210, a graphics-processing unit (GPU) 2215, a system memory 2220, a network 2225, a read-only memory 2230, a permanent storage device 2235, input devices 2240, and output devices 2245.

The bus 2205 collectively represents all system, peripheral, and chipset buses that communicatively connect the numerous internal devices of the electronic system 2200. For instance, the bus 2205 communicatively connects the processing unit(s) 2210 with the GPU 2215, the read-only memory 2230, the system memory 2220, and the permanent storage device 2235.

From these various memory units, the processing unit(s) 2210 retrieves instructions to execute and data to process in order to execute the processes of the present disclosure. The processing unit(s) may be a single processor or a multi-core processor in different embodiments. Some instructions are passed to and executed by the GPU 2215. The GPU 2215 can offload various computations or complement the image processing provided by the processing unit(s) 2210.

The read-only-memory (ROM) 2230 stores static data and instructions that are used by the processing unit(s) 2210 and other modules of the electronic system. The permanent storage device 2235, on the other hand, is a read-and-write memory device. This device is a non-volatile memory unit that stores instructions and data even when the electronic system 2200 is off. Some embodiments of the present disclosure use a mass-storage device (such as a magnetic or optical disk and its corresponding disk drive) as the permanent storage device 2235.

Other embodiments use a removable storage device (such as a floppy disk, flash memory device, etc., and its corresponding disk drive) as the permanent storage device. Like the permanent storage device 2235, the system memory 2220 is a read-and-write memory device. However, unlike storage device 2235, the system memory 2220 is a volatile read-and-write memory, such a random access memory. The system memory 2220 stores some of the instructions and data that the processor uses at runtime. In some embodiments, processes in accordance with the present disclosure are stored in the system memory 2220, the permanent storage device 2235, and/or the read-only memory 2230. For example, the various memory units include instructions for processing multimedia clips in accordance with some embodiments. From these various memory units, the processing unit(s) 2210 retrieves instructions to execute and data to process in order to execute the processes of some embodiments.

The bus 2205 also connects to the input and output devices 2240 and 2245. The input devices 2240 enable the user to communicate information and select commands to the electronic system. The input devices 2240 include alphanumeric keyboards and pointing devices (also called “cursor control devices”), cameras (e.g., webcams), microphones or similar devices for receiving voice commands, etc. The output devices 2245 display images generated by the electronic system or otherwise output data. The output devices 2245 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 22, bus 2205 also couples electronic system 2200 to a network 2225 through a network adapter (not shown). In this manner, the computer can be a part of a network of computers (such as a local area network (“LAN”), a wide area network (“WAN”), or an Intranet, or a network of networks, such as the Internet. Any or all components of electronic system 2200 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 18 and FIG. 21) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of pixels of a current picture of a video;
deriving a linear model based on source and target samples collected from a template region neighboring the current block,
wherein the linear model generates a prediction for one target sample based on a set of neighboring source samples,
wherein the target sample is in a next column or next row to the set of source samples;
applying the linear model to generate a predictor of the current block; and
encoding or decoding the current block by using the generated predictor.

2. The video coding method of claim 1, wherein the target sample is processed in parallel as the set of source samples.

3. The video coding method of claim 1, wherein applying the linear model comprises using reconstructed samples as input to the linear model.

4. The video coding method of claim 1, wherein applying the linear model comprises using a predefined value as input to the linear model.

5. The video coding method of claim 1, wherein applying the linear model comprises using predicted samples as input to the linear model.

6. The video coding method of claim 5, wherein the predicted samples comprise one or more samples that are predicted by the linear model.

7. The video coding method of claim 5, wherein the predicted samples comprise one or more samples that are predicted by an intra prediction mode.

8. The video coding method of claim 7, wherein the intra prediction mode identifies an angular prediction, planar prediction, or DC prediction.

9. The video coding method of claim 1, wherein the linear model is applied to generate prediction for only a subset of the pixel positions of the current block.

10. The video coding method of claim 9, wherein the subset of pixel positions are in N rows closest to the top border of the current block and/or M columns closest to the left border of the current block.

11. The video coding method of claim 1, wherein the predictor is a first predictor of the current block, the method further comprises generating a second predictor of the current block using an intra prediction mode, wherein the current block is encoded or decoded by combining the first and second predictors.

12. The video coding method of claim 1, wherein for a sample position of the current block, one linear model is selected from a plurality of linear models based on a comparison between an available sample for the sample position and a multi-model threshold, the selected linear model to be applied to generate a predictor for the sample position.

13. The video coding method of claim 12, wherein the multi-model threshold is an average of reconstructed samples neighboring the current block.

14. The video coding method of claim 1, wherein for a sample position of the current block, one linear model is selected from a plurality of linear models based on the sample position to be applied to generate a predictor for the sample position.

15. An electronic apparatus comprising:
a video coder circuit configured to perform operations comprising:
receiving data to be encoded or decoded as a current block of pixels of a current picture of a video;
deriving a linear model based on source and target samples collected from a template region neighboring the current block,
wherein the linear model generates a prediction for one target sample based on a set of neighboring source samples,
wherein the target sample is in a next column or next row to the set of source samples;
applying the linear model to generate a predictor of the current block; and
encoding or decoding the current block by using the generated predictor.

16. A video decoding method comprising:
receiving data to be decoded as a current block of pixels of a current picture of a video;
deriving a linear model based on source and target samples collected from a template region neighboring the current block,
wherein the linear model generates a prediction for one target sample based on a set of neighboring source samples,
wherein the target sample is in a next column or next row to the set of source samples;
applying the linear model to generate a predictor of the current block; and
reconstructing the current block by using the generated predictor.

17. A video encoding method comprising:
receiving data to be encoded as a current block of pixels of a current picture of a video;
deriving a linear model based on source and target samples collected from a template region neighboring the current block,
wherein the linear model generates a prediction for one target sample based on a set of neighboring source samples,
wherein the target sample is in a next column or next row to the set of source samples;
applying the linear model to generate a predictor of the current block; and
encoding the current block by using the generated predictor.
